(19) United States
(12) Patent Application Publication
(10) Pub. No.: US 2025/0171599 A1
(43) Pub. Date: May 29, 2025

(54) PREPARATION METHOD OF HIGH-STRENGTH FLAME-RETARDANT POLYESTER MATERIAL

(71) Applicant: NAN YA PLASTICS CORPORATION, Taipei City (TW)

(72) Inventors: Te-Chao Liao, Taipei City (TW); Wen-Cheng Yang, Taipei City (TW); Chun-Che Tsao, Taipei City (TW); Chia-Yen Hsiao, Taipei City (TW); Ci Syuan Liou, Taipei City (TW)

(73) Assignee: NAN YA PLASTICS CORPORATION, Taipei City (TW)

(21) Appl. No.: 18/412,989

(22) Filed: Jan. 15, 2024

(30) Foreign Application Priority Data
Nov. 29, 2023 (TW) 112146395

(51) Int. Cl. C08J 3/21; C08J 3/12; C08K 7/00

(52) U.S. Cl. CPC C08J 3/212; C08J 3/124; C08K 7/00

(57) ABSTRACT

The disclosure provides a preparation method of a polyester material, which is a continuous process and includes the following steps. A recycled release film is crushed, compacted and dried, and then melted, extruded and degassed. After filtration, a liquid viscosifying system is used for thickening. After that, it is melted and kneaded, modified with modifiers and extruded, and then pelletized and dehydrated to make the polyester material, wherein the modifiers include nucleating agents, flame retardants, antioxidants, rod-shaped filling reinforcements and compatibilizers.

### CROSS-REFERENCE TO RELATED APPLICATION

This application claims the priority benefit of Taiwan application serial no. 112146395, filed on Nov. 29, 2023. The entirety of the above-mentioned patent application is hereby incorporated by reference herein and made a part of this specification.

### BACKGROUND

### Technical Field

The disclosure relates to a preparation method of a polyester material, and in particular, to a preparation method of a high-strength flame-retardant polyester material.

### Description of Related Art

In the existing technical field of high-strength flame-retardant polyester material preparation methods, the mixing and modification technology is off-line (non-continuous) extrusion mixing and modification, which mainly adopts a segmented process. In more detail, for example, process one, process two and process three can be carried out in a segmented manner. In the process one, the recycled release film is crushed, the broken film is compacted and dried, and then melted, extruded and degassed. After filtering, pelletizing and dehydration, low-viscosity PET recycled granules can be obtained. After that, process two is carried out. In process two, the low-viscosity PET recycled granules are solid-state polymerized and mixed with an expansion agent to form medium- and high-viscosity PET recycled granules. Finally, process three is carried out. In process three, the medium- and high-viscosity PET recycled granules are melted, kneaded, extruded and modified using a modifier, and then pelletized and dehydrated to obtain a high-strength flame-retardant polyester material. That is to say, the existing high-strength flame-retardant polyester material preparation method mainly uses the segmented process of process one, process two and process three to perform off-line (non-continuous) extrusion, mixing and modification.

As environmental awareness is gradually being taken seriously, international brands are gradually moving towards the trend of circular economy, energy conservation and carbon reduction, and introducing low-carbon emission recycled materials into products is the important goal. However, the existing preparation method of high-strength flame-retardant polyester materials using segmented processes is inefficient and high-energy-consuming, which is not in line with the global environmental protection trend of plastic reduction and energy conservation.

Based on the above, developing a preparation method of high-strength flame-retardant polyester materials, so as to improve production efficiency and reduce energy consumption, thereby complying with the global environmental protection trend of plastic reduction and energy conservation, is an important topic currently required for research.

### SUMMARY

The disclosure provides a preparation method of polyester materials, which mainly adopts a continuous process and performs molten state feeding and modification technology to reduce the waste of energy consumption due to repeated temperature rise and fall, so it is more energy-saving.

The disclosure provides a preparation method of a polyester material, which is a continuous process and includes the following steps. A recycled release film is crushed, compacted and dried, and then melted, extruded and degassed. After filtration, a liquid viscosifying system is used for thickening. After that, it is melted and kneaded, modified with modifiers and extruded, and then pelletized and dehydrated to make the polyester material, wherein the modifiers include nucleating agents, flame retardants, antioxidants, rod-shaped filling reinforcements and compatibilizers.

In an embodiment of the disclosure, the preparation method of the polyester material further includes removing a surface coating of the recycled release film using a film surface ceramic slurry removal technology before the recycled release film is crushed, compacted and dried.

In an embodiment of the disclosure, the liquid viscosifying system is used to increase an intrinsic viscosity (IV) from a viscosity range of 0.5 dl/g to 0.62 dl/g to a viscosity range of 0.7 dl/g to 0.9 dl/g.

In an embodiment of the disclosure, a temperature at which the recycled release film is crushed, compacted and dried is 100° C. to 160° C.

In an embodiment of the disclosure, a temperature of melting, extruding and degassing is 240° C. to 280° C.

In an embodiment of the disclosure, a temperature of melting and kneading is 230° C. to 275° C.

In an embodiment of the disclosure, a temperature of modification and extruding is 230° C. to 280° C.

In an embodiment of the disclosure, the nucleating agents include organic nucleating agents, inorganic nucleating agents or blends thereof.

In an embodiment of the disclosure, the organic nucleating agents include organic sodium salts, the organic sodium salts include sodium benzoate, sodium montanate or ethylene-methacrylic acid copolymer (EMAA).

In an embodiment of the disclosure, the inorganic nucleating agents include inorganic micro-nano powders, the inorganic micro-nano powders include talc, titanium dioxide, silica or calcium carbonate.

In an embodiment of the disclosure, the flame retardants include halogen-free flame retardants, the halogen-free flame retardants include nitrogen-based flame retardants, phosphorus-based flame retardants or composite blends thereof.

In an embodiment of the disclosure, the antioxidants include hindered phenolic antioxidants, phenolic antioxidants, mixed antioxidants, phosphite antioxidants, complex antioxidants or combinations thereof.

In an embodiment of the disclosure, the rod-shaped filling reinforcements include siloxane modified glass fibers.

In an embodiment of the disclosure, the compatibilizers include ethylene-methyl acrylate-glycidyl methacrylate copolymer (E-MA-GMA), polyolefin elastomer graft glycidyl methacrylate (POE-g-GMA), polyethylene graft glycidyl methacrylate glycerides (PE-g-GMA) or a combination thereof.

In an embodiment of the disclosure, based on a total weight of the polyester material, an added amount of the nucleating agents is 0.5 wt % to 3 wt %, an added amount of the flame retardants is 10 wt % to 18 wt %, an added amount of the antioxidants is 0.1 wt % to 1 wt %, an added amount of the rod-shaped filling reinforcements is 25 wt % to 32 wt %, and an added amount of the compatibilizers is 0.5 wt % to 5 wt %.

Based on the above, the disclosure provides a preparation method of polyester materials, which mainly adopts a continuous process and performs molten state feeding and modification technology to reduce the waste of energy consumption due to repeated temperature rise and fall, so it is more energy-saving. In addition, the disclosure improves the problems of slow crystallization speed, insufficient impact strength and rigidity of PET materials through mixing and modification technology, so that it can be used in injection molding applications for industrial connectors, fans, sports equipment or battery and electrical appliance casings.

### DESCRIPTION OF THE EMBODIMENTS

Embodiments of the disclosure will be described in details below. However, these embodiments are illustrative, and the disclosure is not limited thereto.

Herein, a range indicated by “one value to another value” is a general representation which avoids enumerating all values in the range in the specification. Therefore, the description of a specific numerical range covers any numerical value within the numerical range and the smaller numerical range bounded by any numerical value within the numerical range, as if the arbitrary numerical value and the smaller numerical range are written in the specification.

The disclosure provides a preparation method of a polyester material, which is a continuous process and includes the following steps. First, a surface coating of a recycled release film is removed using a film surface ceramic slurry removal technology. Next, the recycled release film is crushed, compacted and dried, and then enters a melt extruder for melt extrusion and degassing. After filtration, a liquid viscosifying system is used for continuous online viscosification. After that, it is melted and kneaded, modified with modifiers and extruded, and then pelletized and dehydrated to make a high-strength flame-retardant and environmentally friendly polyester material that meets the UL 94 test 1.2 mm V0 standard.

In the present embodiment, a liquid viscosifying system is used to increase the intrinsic viscosity (IV) from a viscosity range of 0.5 dl/g to 0.62 dl/g to a viscosity range of 0.7 dl/g to 0.9 dl/g. As a result, the mechanical properties, flame retardancy and fluidity of environmentally friendly recycled granules can be equivalent to those of virgin granules.

In the present embodiment, a temperature for crushing, compacting and drying the recycled release film is, for example, 100° C. to 160° C.; a temperature of melting, extruding and degassing is, for example, 240° C. to 280° C.; a temperature of melting and kneading is, for example, 230° C. to 275° C.; and a temperature of modification and extruding is, for example, 230° C. to 280° C.

In the present embodiment, modifiers can include nucleating agents, flame retardants, antioxidants, rod-shaped filling reinforcements and compatibilizers. Below, the various components mentioned above will be described in detail.

### Nucleating Agents

In the present embodiment, the nucleating agents can include organic nucleating agents, inorganic nucleating agents or blends thereof. The organic nucleating agents include organic sodium salts, and the organic sodium salts include sodium benzoate, sodium montanate or ethylene-methacrylic acid copolymer (EMAA). The inorganic nucleating agents include inorganic micro-nano powders, and the inorganic micro-nano powders include talc, titanium dioxide, silica or calcium carbonate. Based on a total weight of the polyester material, an added amount of the nucleating agents is 0.5 wt % to 3 wt %, for example. Preferably, the compound is composed of an organic nucleating agent and an inorganic nucleating agent. At this time, based on the total weight of the polyester material, the added amount is, for example, 1 wt % to 2 wt %. Adding nucleating agents can increase the crystallization and solidification speed of PET materials, thereby improving its processability.

### Flame Retardants

In the present embodiment, in order to meet the requirement of RoHS and halogen free for product, a flame retardant is a halogen free flame retardant. The halogen free flame retardant may include a nitrogen flame retardant, a phosphorus flame retardant or composite blends thereof. The phosphorus flame retardant may include pentaerythritol bisphosphate melamine salt (MPP), ammonium polyphosphate (APP), toluene xylyl phosphate or hypophosphite. The nitrogen flame retardant may include melamine cyanurate (MCA), melamine, etc. More particularly, the compound effect of hypophosphite and melamine cyanurate (MCA) is better. The ratio of hypophosphite to melamine cyanurate (MCA) is 3:1 to 1:1, for example. Based on a total weight of the polyester material, an added amount of the flame retardant is 10 wt % to 18 wt %, for example. The flame retardant can inhibit the combustion of PET through carbonization on the surface and improve the flame retardant properties.

### Antioxidant

In the present embodiment, an antioxidant may include a hindered phenol antioxidant, a phenol antioxidant, a hybrid antioxidant, a phosphite antioxidant, a compound antioxidant or a combination thereof. Based on a total weight of the polyester material, an added amount of the antioxidant is 0.1 wt % to 1 wt %, for example. The antioxidant can improve the heat resistance and processability of the material.

### Rod-Shaped Filling Reinforcements

In the present embodiment, rod-shaped filling reinforcements may include siloxane-modified glass fibers. The surface is modified with siloxane to improve the compatibility. A diameter of the glass fiber is 10 μm to 13 μm, and a length of a cut strand is 3 mm to 4 mm, for example. Based on a total weight of the polyester material, an added amount of the rod-shaped filling reinforcements is 25 wt % to 32 wt %, for example. The rod-shaped filling reinforcements can effectively improve the impact strength and rigidity of the material, and the improvement effect of physical properties is directly related to the dispersion degree of the rod-shaped filling reinforcements. Therefore, it is necessary to simultaneously introduce a compatibilizer grafted with GMA to improve the rod-shaped filling reinforcement's dispersibility in PET.

### Compatibilizer

In the present embodiment, a compatibilizer may include ethylene-methyl acrylate-glycidyl methacrylate copolymer (E-MA-GMA), polyolefin elastomer graft glycidyl methacrylate (POE-g-GMA), polyethylene graft glycidyl methacrylate glycerides (PE-g-GMA) or a combination thereof. Based on a total weight of the polyester material, an added amount of the compatibilizer is 0.5 wt % to 5 wt %, for example. The compatibilizer can improve the compatibility between rod-shaped filling reinforcement and PET resin to improve the material reinforcement effect.

Below, the above-mentioned preparation method of a high-strength flame-retardant polyester material of the disclosure is described in detail by experimental example. However, the following experimental examples are not intended to limit the disclosure.

### Experimental Examples

In order to prove that the preparation method of polyester material proposed by the disclosure can produce high-strength flame-retardant and environmentally friendly polyester materials, so as to improve flame-retardant properties and the problems of slow crystallization speed, insufficient impact strength and rigidity, this experimental example is specially performed below.

### Test Methods

Specific gravity: ASTM D792
Tensile strength, elongation: ASTM D638
Bending strength, bending modulus: ASTM D790
Flame retardant: UL94

### Material Property Evaluation

Industrial parts made of PBT+30% GF, unmodified PET, recycled PET+30% glass fiber and polyester materials produced by the preparation method of the disclosure were tested according to the above test method. The test results are listed in the following Table 1. Since the preparation method of the polyester material of the disclosure has been described in detail above, it will not be described in detail here. The preparation conditions for the polyester material produced by the preparation method of the disclosure in Table 1 are as follows: a liquid viscosifying system is used for thickening, the intrinsic viscosity (IV) is increased to 0.8 dl/g, the recycled release film is crushed, compacted and dried at 120° C., the temperature for melt extrusion and degassing is 255° C., the temperature for melting and kneading is 265° C., and the temperature for modification and extrusion is 270° C.; based on the total weight of the polyester material, the added amount of nucleating agents is 1.5 wt %, the added amount of flame retardant is 12 wt %, the added amount of antioxidant is 0.2 wt %, the added amount of rod-shaped filling reinforcement is 30 wt %, and the added amount of compatibilizer is 2.5 wt %.

As can be seen from Table 1 below, the impact resistance, rigidity (bending modulus), and flame retardancy of unmodified PET materials cannot meet the needs of industrial component products. Although recycled PET+30% glass fiber can meet the physical property requirements of parts, it has no flame retardant effect. In comparison, the polyester material produced by the preparation method of the disclosure and PBT+30% glass fiber for industrial parts also have flame retardant and heat-resistant properties, and at the same time have good mechanical properties, reaching the UL 94 test 1.2 mm V0 standard. The problems of slow crystallization speed and insufficient strength are improved through the modification of crystal nucleating agents and rod-shaped filling reinforcements.

TABLE 1

| | | PBT + 30% | | | |
|---|---|---|---|---|---|
| | | GF for | | | Flame-retardant |
| | | industrial | Unmodified | Recycled | polyester material |
| | | parts | PET | PET + 30% GF | of the disclosure |
| Mechanical | Specific gravity | 1.59 | 1.35 | 1.52 | 1.58 |
| properties | Impact strength (kg- | 8 | 3.5 | 8 | 7.5 |
| | cm/cm) | | | | |
| | Tensile strength | 110 | 60 | 135 | 100 |
| | (MPa) | | | | |
| | Elongation (%) | 3.5 | 5.2 | 3.2 | 3.2 |
| | Bending strength | 150 | 88 | 160 | 148 |
| | (MPa) | | | | |
| | Bending modulus | 8000 | 2400 | 8500 | 9000 |
| | (MPa) | | | | |
| Flame | UL94 flame retardant | 1.5 mm V0 | HB | HB | 1.2 mm V0 |
| retardant | | | | | |
| properties | | | | | |
| Heat | Heat distortion | 206 | 70 | 212 | 210 |
| resistance | temperature | | | | |
| properties | | | | | |

In summary, the disclosure provides a preparation method of polyester materials, which mainly adopts a continuous process and performs molten state feeding and modification technology to reduce the waste of energy consumption of repeated temperature rise and fall, so it is more energy-saving. In this way, the problems of low efficiency and high energy consumption in the segmented process of the existing high-strength flame-retardant polyester material preparation method can be effectively improved. In addition, the disclosure improves the problems of slow crystallization speed, insufficient impact strength and rigidity of PET materials through mixing and modification technology, so that it can be used in injection molding applications for industrial connectors, fans, sports equipment or battery and electrical appliance casings. On the other hand, the disclosure uses recycled release film as PET raw material, and its mechanical properties, flame retardancy and fluidity are equivalent to virgin graunules. Therefore, it will contribute to the global goal of plastic reduction and energy saving.

What is claimed is:

1. A preparation method of a polyester material, which is a continuous process, comprising:
crushing, compacting and drying a recycled release film, and then melting, extruding and degassing the recycled release film;
after filtration, using a liquid viscosifying system for thickening; and
performing melting and kneading, and modifiers are used for modification and extruding, and then pelletizing and dehydrating to make the polyester material, wherein the modifiers include nucleating agents, flame retardants, antioxidants, rod-shaped filling reinforcements and compatibilizers.

2. The preparation method of the polyester material according to claim 1, further comprising removing a surface coating of the recycled release film using a film surface ceramic slurry removal technology before the recycled release film is crushed, compacted and dried.

3. The preparation method of the polyester material according to claim 1, wherein the liquid viscosifying system is used to increase an intrinsic viscosity (IV) from a viscosity range of 0.5 dl/g to 0.62 dl/g to a viscosity range of 0.7 dl/g to 0.9 dl/g.

4. The preparation method of the polyester material according to claim 1, wherein a temperature at which the recycled release film is crushed, compacted and dried is 100° C. to 160° C.

5. The preparation method of the polyester material according to claim 1, wherein a temperature of melting, extruding and degassing is 240° C. to 280° C.

6. The preparation method of the polyester material according to claim 1, wherein a temperature of melting and kneading is 230° C. to 275° C.

7. The preparation method of the polyester material according to claim 1, wherein a temperature of modification and extruding is 230° C. to 280° C.

8. The preparation method of the polyester material according to claim 1, wherein the nucleating agents include organic nucleating agents, inorganic nucleating agents or blends thereof.

9. The preparation method of the polyester material according to claim 8, wherein the organic nucleating agents include organic sodium salts, the organic sodium salts include sodium benzoate, sodium montanate or ethylene-methacrylic acid copolymer (EMAA).

10. The preparation method of the polyester material according to claim 8, wherein the inorganic nucleating agents include inorganic micro-nano powders, the inorganic micro-nano powders include talc, titanium dioxide, silica or calcium carbonate.

11. The preparation method of the polyester material according to claim 1, wherein the flame retardants include halogen-free flame retardants, the halogen-free flame retardants include nitrogen-based flame retardants, phosphorus-based flame retardants or composite blends thereof.

12. The preparation method of the polyester material according to claim 1, wherein the antioxidants include hindered phenolic antioxidants, phenolic antioxidants, mixed antioxidants, phosphite antioxidants, complex antioxidants or combinations thereof.

13. The preparation method of the polyester material according to claim 1, wherein the rod-shaped filling reinforcements include siloxane modified glass fibers.

14. The preparation method of the polyester material according to claim 1, wherein the compatibilizers include ethylene-methyl acrylate-glycidyl methacrylate copolymer (E-MA-GMA), polyolefin elastomer graft glycidyl methacrylate (POE-g-GMA), polyethylene graft glycidyl methacrylate glycerides (PE-g-GMA) or a combination thereof.

15. The preparation method of the polyester material according to claim 1, wherein based on a total weight of the polyester material, an added amount of the nucleating agents is 0.5 wt % to 3 wt %, an added amount of the flame retardants is 10 wt % to 18 wt %, an added amount of the antioxidants is 0.1 wt % to 1 wt %, an added amount of the rod-shaped filling reinforcements is 25 wt % to 32 wt %, and an added amount of the compatibilizers is 0.5 wt % to 5 wt %.
